(19) United States
(12) Patent Application Publication
(10) Pub. No.: US 2023/0336933 A1
(43) Pub. Date: Oct. 19, 2023

(54) SHAPED PIEZOELECTRIC ACTUATOR FOR MEDICAL IMPLANT

(71) Applicant: Cochlear Limited, Macquarie University, NSW (AU)

(72) Inventors: Charles Roger Leigh, Macquarie University (AU); Stijn Eeckhoudt, Mechelen (BE); Koen Erik Van den Heuvel, Mechelen (BE)

(21) Appl. No.: 18/044,547

(22) PCT Filed: Sep. 7, 2021
(86) PCT No.: PCT/IB2021/058141

§ 371 Date: Mar. 8, 2023

Related U.S. Application Data
(60) Provisional application No. 63/104,132, filed on Oct. 22, 2020.

(51) Int. Cl. H04R 25/00; H04R 17/10

(52) U.S. Cl. CPC H04R 25/606; H04R 17/10; H04R 2460/13; H04R 2225/67

(57) ABSTRACT

An apparatus includes at least one vibration-generating actuator having a coupler configured to be in mechanical communication with a fixture, at least one mass spaced from the coupler, and at least one non-planar piezoelectric element in mechanical communication with the coupler and the at least one mass. The at least one non-planar piezoelectric element is configured to oscillate the at least one mass relative to the coupler in response to received electric voltage signals. The fixture and the at least one actuator can be configured to be implanted on or within a recipient's body, and the fixture can be configured to transmit the vibrations to the recipient's body such that the vibrations evoke a hearing precept by the recipient.

### BACKGROUND

### Field

The present application relates generally to an implantable piezoelectric actuator for generating vibrations, and more specifically, to implantable auditory prostheses for generating auditory vibrations.

### Description of the Related Art

Medical devices have provided a wide range of therapeutic benefits to recipients over recent decades. Medical devices can include internal or implantable components/devices, external or wearable components/devices, or combinations thereof (e.g., a device having an external component communicating with an implantable component). Medical devices, such as traditional hearing aids, partially or fully-implantable hearing prostheses (e.g., bone conduction devices, mechanical stimulators, cochlear implants, etc.), pacemakers, defibrillators, functional electrical stimulation devices, and other medical devices, have been successful in performing lifesaving and/or lifestyle enhancement functions and/or recipient monitoring for a number of years.

The types of medical devices and the ranges of functions performed thereby have increased over the years. For example, many medical devices, sometimes referred to as “implantable medical devices,” now often include one or more instruments, apparatus, sensors, processors, controllers or other functional mechanical or electrical components that are permanently or temporarily implanted in a recipient. These functional devices are typically used to diagnose, prevent, monitor, treat, or manage a disease/injury or symptom thereof, or to investigate, replace or modify the anatomy or a physiological process. Many of these functional devices utilize power and/or data received from external devices that are part of, or operate in conjunction with, implantable components.

### SUMMARY

In one aspect disclosed herein, an apparatus comprises at least one actuator configured to generate vibrations. The at least one actuator comprises a coupler configured to be in mechanical communication with a fixture, at least one mass spaced from the coupler, and at least one non-planar piezoelectric element in mechanical communication with the coupler and the at least one mass. The at least one non-planar piezoelectric element is configured to oscillate the at least one mass relative to the coupler in response to received electric voltage signals. For example, in certain aspects, the fixture and the at least one actuator are configured to be implanted on or within a recipient's body, and the fixture is configured to transmit the vibrations to the recipient's body such that the vibrations evoke a hearing precept by the recipient.

In another aspect disclosed herein, a method comprises applying electric voltage signals to at least one element responsive to the electric voltage signals by changing in shape and/or length. The at least one element has a first portion in mechanical communication with a fixture implanted on or within a recipient's body and a second portion affixed to at least one mass and spaced from the first portion. The method further comprises imparting oscillatory motion to the at least one mass. The oscillatory motion comprises a first oscillating component in a first direction extending from the first portion of the at least one element to the second portion of the at least one element and a second oscillating component in a second direction substantially perpendicular to the first direction. The first oscillating component has a first maximum amplitude and the second oscillating component has a second maximum amplitude less than or equal to ten times the first maximum amplitude.

In another aspect disclosed herein, an apparatus comprises a coupler configured to be in mechanical communication with a fixture implanted on or within a recipient's body. The apparatus further comprises at least one piezoelectric element in mechanical communication with the coupler. The at least one piezoelectric element comprises an edge face spaced from the coupler. The apparatus further comprises at least one mass affixed to the at least one piezoelectric element. The at least one mass is spaced from the coupler and is not covering the edge face of the at least one piezoelectric element.

### BRIEF DESCRIPTION OF THE DRAWINGS

Implementations are described herein in conjunction with the accompanying drawings, in which:

FIG. 1A schematically illustrates a portion of an example transcutaneous bone conduction device implanted in a recipient in accordance with certain implementations described herein;

FIG. 1B schematically illustrate a portion of another example transcutaneous bone conduction device implanted in a recipient in accordance with certain implementations described herein;

FIGS. 2A and 2B schematically illustrate cross-sectional views of a portion of an apparatus comprising at least one actuator configured to generate vibrations in accordance with certain implementations described herein;

FIG. 3A schematically illustrates a cross-sectional view of an apparatus comprising at least one mass extending over top and bottom surfaces of the edge portion of the piezoelectric element but not extending over an edge face of the edge portion in accordance with certain implementations described herein;

FIG. 3B schematically illustrates a cross-sectional view of an apparatus comprising a unitary mass in a region at least partially bounded by a portion of the piezoelectric element that deviates from a planar shape in accordance with certain implementations described herein;

FIG. 3C schematically illustrates a cross-sectional view of an apparatus comprising a plurality of unitary masses affixed to and distributed along the piezoelectric element in accordance with certain implementations described herein;

FIG. 4 schematically illustrates an apparatus comprising a first plurality of electrodes in electrical communication with a first electrical voltage signal source and a second plurality of electrodes in electrical communication with a second electrical voltage signal source configured to be operated independently from the first electrical voltage signal source in accordance with certain implementations described herein;

FIG. 5A shows example calculations of the natural frequency of an example model of a piezoelectric element having a sinusoidal cross-sectional shape as a function of number of periods (N) and the ratio (A/L) of amplitude (A) to length (L) of the piezoelectric element in accordance with certain implementations described herein;

FIG. 5B schematically illustrates the sinusoidal cross-sectional shape of the piezoelectric element of FIG. 5A in accordance with certain implementations described herein;

FIGS. 6A and 6B schematically illustrate cross-sectional views of two example actuators in accordance with certain implementations described herein; and

FIG. 7 is a flow diagram of an example method in accordance with certain implementations described herein.

### DETAILED DESCRIPTION

Certain implementations described herein provide an actuator for generating vibrations in response to electrical signals, the actuator comprising at least one piezoelectric element (e.g., sheet; arm) having a non-planar shape. The non-planar-shaped piezoelectric element can have a lower resonant frequency for the same effective length than a planar-shaped (e.g., flat) piezoelectric element. For example, to provide a low resonant frequency, the flat piezoelectric elements of prior actuators are relatively long and are coupled to relatively large masses which increase the form-factor or size of the actuators, impacting surgical complexity, susceptibility to impact, and cosmetics. Due at least partially to utilizing non-planar-shaped piezoelectric elements, certain implementations described herein achieve smaller form-factors (e.g., smaller packaging) and potentially greater customization of the actuation dynamics.

The teachings detailed herein are applicable, in at least some implementations, to any type of implantable medical device (e g , implantable stimulation system) comprising a first portion implanted on or within the recipient's body and configured to provide vibrations to a portion of the recipient's body Implementations can include any type of medical device that can utilize the teachings detailed herein and/or variations thereof. Furthermore, while certain implementations are described herein in the context of implantable devices, certain other implementations are compatible in the context of non-implantable devices. For example, low resonant frequency within a smaller form-factor and greater customization of the actuation dynamics can be provided, at least in part, by at least one non-planar piezoelectric element in a non-implantable device.

Merely for ease of description, apparatus and methods disclosed herein are primarily described with reference to an illustrative medical device, namely an active transcutaneous bone conduction auditory prosthesis. However, the teachings detailed herein and/or variations thereof may also be used with a variety of other medical devices that provide a wide range of therapeutic benefits to recipients, patients, or other users. In some implementations, the teachings detailed herein and/or variations thereof can be utilized in other types of devices beyond auditory prostheses that may benefit from a vibration-generating actuator able to fit within a region having restricted space and/or improved control of piezoelectric vibrations (e.g., a direction of vibration motion). For example, apparatus and methods disclosed herein and/or variations thereof may also be used with control sensors configured to measure liquid levels.

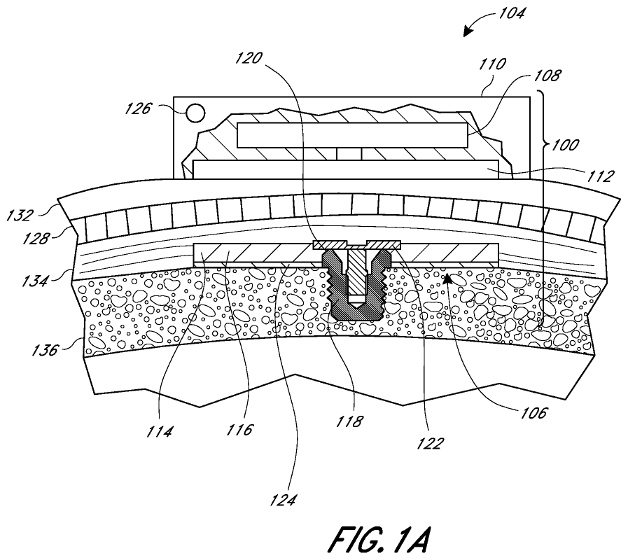

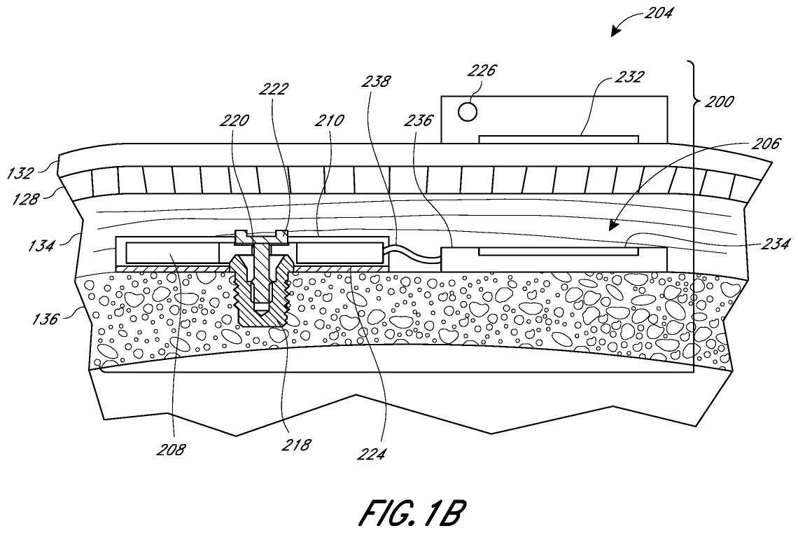

FIG. 1A schematically illustrates a portion of an example transcutaneous bone conduction device 100 implanted in a recipient in accordance with certain implementations described herein. FIG. 1B schematically illustrate a portion of another example transcutaneous bone conduction device 200 implanted in a recipient in accordance with certain implementations described herein.

The example transcutaneous bone conduction device 100 of FIG. 1A includes an external device 104 and an implantable component 106. The transcutaneous bone conduction device 100 of FIG. 1A is a passive transcutaneous bone conduction device in that a vibrating actuator 108 is located in the external device 104 and delivers vibrational stimuli through the skin 132 to the skull 136. The vibrating actuator 108 is located in a housing 110 of the external component 104 and is coupled to a plate 112. The plate 112 can be in the form of a permanent magnet and/or in another form that generates and/or is reactive to a magnetic field, or otherwise permits the establishment of magnetic attraction between the external device 104 and the implantable component 106 sufficient to hold the external device 104 against the skin 132 of the recipient.

In certain implementations, the vibrating actuator 108 is a device that converts electrical signals into vibration. In operation, a sound input element 126 can convert sound into electrical signals. Specifically, the transcutaneous bone conduction device 100 can provide these electrical signals to the vibrating actuator 108, or to a sound processor (not shown) that processes the electrical signals, and then provides those processed signals to the vibrating actuator 108. The vibrating actuator 108 can convert the electrical signals (processed or unprocessed) into vibrations. Because the vibrating actuator 108 is mechanically coupled to the plate 112, the vibrations are transferred from the vibrating actuator 108 to the plate 112. The implanted plate assembly 114 is part of the implantable component 106, and is made of a ferromagnetic material that may be in the form of a permanent magnet, that generates and/or is reactive to a magnetic field, or otherwise permits the establishment of a magnetic attraction between the external device 104 and the implantable component 106 sufficient to hold the external device 104 against the skin 132 of the recipient. Accordingly, vibrations produced by the vibrating actuator 108 of the external device 104 are transferred from the plate 112 across the skin 132 to a plate 116 of the plate assembly 114. This can be accomplished as a result of mechanical conduction of the vibrations through the skin 132, resulting from the external device 104 being in direct contact with the skin 132 and/or from the magnetic field between the two plates 112, 116. These vibrations are transferred without a component penetrating the skin 132, fat 128, or muscular 134 layers on the head.

In certain implementations, the implanted plate assembly 114 is substantially rigidly attached to a bone fixture 118. The implantable plate assembly 114 can include a through hole 120 that is contoured to the outer contours of the bone fixture 118. This through hole 120 thus forms a bone fixture interface section that is contoured to the exposed section of the bone fixture 118. In certain implementations, the sections are sized and dimensioned such that at least a slip fit or an interference fit exists with respect to the sections. A screw 122 can be used to secure the plate assembly 114 to the bone fixture 118. In certain implementations, a silicone layer 124 is located between the plate 116 and the bone 136 of the skull.

As can be seen in FIG. 1A, the head of the screw 122 is larger than the hole through the implantable plate assembly 114, and thus the screw 122 positively retains the implantable plate assembly 114 to the bone fixture 118. The portions of the screw 122 that interface with the bone fixture 118 substantially correspond to an abutment screw, thus permitting the screw 122 to readily fit into an existing bone fixture used in a percutaneous bone conduction device. In certain implementations, the screw 122 is configured so that the same tools and procedures that are used to install and/or remove an abutment screw from the bone fixture 118 can be used to install and/or remove the screw 122 from the bone fixture 118.

As schematically illustrated by FIG. 1B, an example transcutaneous bone conduction device 200 comprises an external device 204 and an implantable component 206. The device 200 is an active transcutaneous bone conduction device in that the vibrating actuator 208 is located in the implantable component 206. For example, a vibratory element in the form of a vibrating actuator 208 is located in a housing 210 of the implantable component 206. In certain implementations, much like the vibrating actuator 108 described herein with respect to the transcutaneous bone conduction device 100, the vibrating actuator 208 is a device that converts electrical signals into vibration. The vibrating actuator 208 can be in direct contact with the outer surface of the recipient's skull 136 (e.g., the vibrating actuator 208 is in substantial contact with the recipient's bone 136 such that vibration forces from the vibrating actuator 208 are communicated from the vibrating actuator 208 to the recipient's bone 136). In certain implementations, there can be one or more thin non-bone tissue layers (e.g., a silicone layer 224) between the vibrating actuator 208 and the recipient's bone 136 (e.g., bone tissue) while still permitting sufficient support so as to allow efficient communication of the vibration forces generated by the vibrating actuator 208 to the recipient's bone 136.

In certain implementations, the external component 204 includes a sound input element 226 that converts sound into electrical signals. Specifically, the device 200 provides these electrical signals to the vibrating actuator 208, or to a sound processor (not shown) that processes the electrical signals, and then provides those processed signals to the implantable component 206 through the skin of the recipient via a magnetic inductance link. For example, a transmitter coil 232 of the external component 204 can transmit these signals to an implanted receiver coil 234 located in a housing 236 of the implantable component 206. Components (not shown) in the housing 236, such as, for example, a signal generator or an implanted sound processor, then generate electrical signals to be delivered to the vibrating actuator 208 via electrical lead assembly 238. The vibrating actuator 208 converts the electrical signals into vibrations. In certain implementations, the vibrating actuator 208 can be positioned with such proximity to the housing 236 that the electrical leads 238 are not present (e.g., the housing 210 and the housing 238 are the same single housing containing the vibrating actuator 208, the receiver coil 234, and other components, such as, for example, a signal generator or a sound processor).

In certain implementations, the vibrating actuator 208 is mechanically coupled to the housing 210. The housing 210 and the vibrating actuator 208 collectively form a vibrating element. The housing 210 can be substantially rigidly attached to a bone fixture 218. In this regard, the housing 210 can include a through hole 220 that is contoured to the outer contours of the bone fixture 218. The screw 222 can be used to secure the housing 210 to the bone fixture 218. As can be seen in FIG. 1B, the head of the screw 222 is larger than the through hole 220 of the housing 210, and thus the screw 222 positively retains the housing 210 to the bone fixture 218. The portions of the screw 222 that interface with the bone fixture 218 substantially correspond to the abutment screw detailed below, thus permitting the screw 222 to readily fit into an existing bone fixture used in a percutaneous bone conduction device (or an existing passive bone conduction device). In certain implementations, the screw 222 is configured so that the same tools and procedures that are used to install and/or remove an abutment screw from the bone fixture 218 can be used to install and/or remove the screw 222 from the bone fixture 218.

The example transcutaneous bone conduction auditory device 100 of FIG. 1A comprises an external sound input element 126 (e.g., external microphone) and the example transcutaneous bone conduction auditory device 200 of FIG. 1B comprises an external sound input element 226 (e.g., external microphone). Other example auditory devices (e.g., totally implantable transcutaneous bone conduction devices) in accordance with certain implementations described herein can replace the external sound input element 126, 226 with a subcutaneously implantable sound input assembly (e.g., implanted microphone).

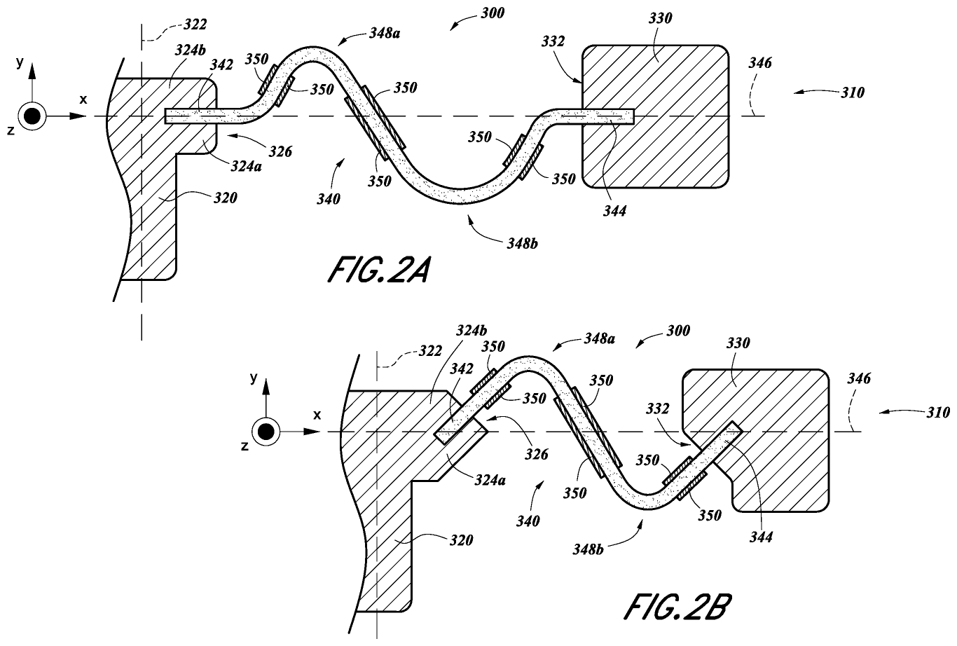

FIGS. 2A and 2B schematically illustrate cross-sectional views of a portion of an apparatus 300 comprising at least one actuator 310 (e.g., piezoelectric actuator) configured to generate vibrations in accordance with certain implementations described herein. The at least one actuator 310 comprises a coupler 320 configured to be in mechanical communication with a fixture (not shown), at least one mass 330 spaced from the coupler 320, and at least one non-planar piezoelectric element 340 in mechanical communication with the coupler 320 and the at least one mass 330. The at least one non-planar piezoelectric element 340 is configured to oscillate the at least one mass 330 relative to the coupler 320 in response to received electric voltage signals.

In certain implementations, the at least one actuator 310 and the fixture (e.g., bone fixture) are configured to be implanted on or within the recipient's body. For example, as schematically illustrated by FIGS. 1A and 1B, the at least one actuator 310 can comprise a vibrating actuator 108, 208 and the fixture can comprise an implant (e.g., an osseointegrated bone fixture 118, 218 and screw 122, 222). The fixture of certain implementations is configured to transmit the vibrations generated by the at least one actuator 310 (e.g., from vibrations of the at least one mass 330 and the at least one piezoelectric element 340) to the recipient's body such that the vibrations evoke a hearing precept by the recipient (e.g., to mechanically vibrate the skull bone of the recipient, the vibrations received by the recipient's cochlea to compensate for conductive hearing loss, mixed hearing loss, or single-sided deafness).

The apparatus 300 of certain implementations further comprises a housing (e.g., housing 110, 210) configured to hermetically seal the at least one mass 330 and the at least one non-planar piezoelectric element 340 from an environment surrounding the at least one actuator 310. The housing can have a length less than or equal to 30 millimeters (e.g., less than 25 millimeters), a width less than or equal to 25 millimeters (e.g., less than 20 millimeters), and/or a thickness less than or equal to 5 millimeters (e.g., less than 4 millimeters). The housing of certain implementations comprises at least one biocompatible material (e.g., ceramic; titanium; titanium alloy) and is configured to provide vibrational isolation such that the fixture is substantially the only pathway through which vibrations travel from the at least one actuator 310 to the recipient's body.

FIGS. 2A and 2B schematically illustrate a portion of the coupler 320 in accordance with certain implementations described herein. In certain implementations, the coupler 320 (e.g., shaft) comprises at least one biocompatible material (e.g., titanium; titanium alloy) and comprises a coupler central axis 322 extending towards the fixture in a direction substantially parallel to a fixture central axis of the fixture. In certain implementations, the coupler 320 comprises at least a first coupling portion 324a and a second coupling portion 324b configured to be in mechanical communication with (e.g., hold; be affixed to) a portion 342 of the at least one piezoelectric element 340 therebetween. For example, the first (e.g., lower) coupling portion 324a can be configured to be mechanically coupled (e.g., screwed; clamped; adhesively bonded) to the fixture which is integrated (e.g., osseointegrated) with the recipient's body, and the second (e.g., upper) coupling portion 324b can be configured to be mechanically coupled (e.g., screwed; clamped; adhesively bonded) to the first coupling portion 324a such that the portion 342 of the at least one piezoelectric element 340 is in mechanical communication (e.g., sandwiched; compressively held; adhesively bonded) between the first and second coupling portions 324a,b. For another example, the first and second coupling portions 324a,b comprise a pair of clamp jaws that hold the portion 342 via a compressive force applied to the first and second coupling portions 324a,b via a screw portion of the coupler 320 being screwed into an osseointegrated bone fixture. In certain other implementations, the coupler 320 is integral with the portion 342 of the at least one piezoelectric element 340.

In certain implementations, the at least one mass 330 comprises one or more materials having sufficiently large mass density and dimensions (e.g., length; width; thickness; volume) such that the at least one mass 330 has a mass (e.g., weight) configured to achieve a predetermined resonant frequency and to vibrate within the confines of the housing without being encumbered by the housing. Examples of such materials include but are not limited to: tungsten; tungsten alloy; osmium; osmium alloy. In certain implementations, the at least one mass 330 is in mechanical communication with (e.g., affixed to) at least one edge portion 344 of the at least one non-planar piezoelectric element 340. While FIGS. 2A and 2B show the at least one mass 330 as a separate component affixed (e.g., bonded) to the at least one non-planar piezoelectric element 340, in certain other implementations, the at least one mass 330 is integral with and comprises at least a portion of the at least one non-planar piezoelectric element 340.

In certain implementations, the at least one non-planar piezoelectric element 340 is a unitary (e.g., single; monolithic) component comprising at least one piezoelectric material, while in certain other implementations, the at least one non-planar piezoelectric element 340 comprises separate components, one or more of which each comprising at least one piezoelectric material. Examples of piezoelectric materials compatible with certain implementations described herein include, but are not limited to: quartz; gallium orthophosphate; langasite; barium titanate; lead titanate; lead zirconate titanate; potassium niobate; lithium niobate; lithium tantalate; sodium tungstate; sodium potassium niobate; bismuth ferrite; sodium niobate; polyvinylidene fluoride; other piezoelectric crystals, ceramics, or polymers. The at least one non-planar piezoelectric element 340 of certain implementations comprises two or more layers in mechanical communication with one another (e.g., bonded together) into a unitary component, at least one of the layers comprising at least one piezoelectric material. The unitary component can comprise other non-piezoelectric materials, such as a bonding material (e.g., adhesive; epoxy; metal) between the piezoelectric layers and/or electrically conductive material (e.g., metal) configured to apply electrical voltage signals to the piezoelectric layers.

In certain implementations, the non-planar piezoelectric element 340 has a length between the coupler 320 and the at least one mass 330, a width perpendicular to the length, and a thickness perpendicular to the width and the length, and the non-planar piezoelectric element 340 has a first natural vibration frequency that is less than that of a planar piezoelectric element having the same length, width, and thickness. For example, the length can be in a range of 6 millimeters to 15 millimeters (e.g., in a range of 8 millimeters to 12 millimeters), the width can be in a range of 6 millimeters to 15 millimeters (e.g., in a range of 8 millimeters to 12 millimeters), and a thickness in a range of less than 2 millimeters (e.g., less than 1 millimeter). Larger dimensions of the non-planar piezoelectric element 340 can result in lower natural vibration frequencies of the non-planar piezoelectric element 340. In certain implementations, the natural frequency of the non-planar piezoelectric element 340 is in a range of 250 Hz to 8 kHz (e.g., the non-planar piezoelectric element 340 is configured to vibrate, in response to electrical voltage signals, at a frequency in a range of 250 Hz to 8 kHz).

In certain implementations, the at least one non-planar piezoelectric element 340 comprises a unitary, non-planar sheet (e.g., plate; disc-shaped) having a hole through which a portion of the coupler 320 (e.g., shaft) extends. The sheet can have a length extending between two edge portions of the sheet and through the hole, a width extending perpendicularly to the length between two other edge portions of the sheet and through the hole, both the length and the width larger than a dimension of the coupler 320 (e.g., length; width) extending along the same direction. In certain such implementations, the portion 342 held by the coupler 320 comprises a portion of the sheet at least partially bounding (e.g., substantially surrounding) the hole through which the coupler 320 extends and the at least one edge portion 344 comprises an edge portion (e.g., perimeter portion) of the sheet that is spaced away from the coupler 320.

In certain other implementations, the at least one non-planar piezoelectric element 340 comprises at least one non-planar arm having a length extending between two end portions of the arm and a width extending perpendicularly to the length between two side portions of the arm, the width smaller than a dimension of the coupler 320 (e.g., width) extending along the same direction. In certain such implementations, for each arm, the portion 342 held by the coupler 320 comprises one of the two end portions of the arm, and the at least one edge portion 344 comprises the other of the two end portions of the arm that is not held by the coupler 320.

In certain implementations, the at least one non-planar piezoelectric element 340 has a cross-sectional shape comprising one or more curves in at least one plane extending through the coupler 320 and the at least one mass 330. In certain implementations, the at least one piezoelectric element 340 generally extends (e.g., from the coupler 320 to the at least one mass 330) along a plane 346 substantially perpendicular to the cross-sectional plane schematically illustrated by FIGS. 2A and 2B and substantially perpendicular to the coupler central axis 322 and comprises at least one portion 348 that deviates from a planar shape (e.g., deviates from the plane 346).

In certain implementations, as schematically illustrated by FIG. 2A, the at least one piezoelectric element 340 comprises at least two portions 348a,b (e.g., curved portions) that have different shapes from one another. For example, a first portion 348a can extend a length along the plane 346 that is shorter than that of a second portion 348b and/or the first portion 348a can deviate from the plane 346 with a shorter maximum distance than does the second portion 348b. In certain other implementations, as schematically illustrated by FIG. 2B, the at least one piezoelectric element 340 can comprise at least two portions 348a,b (e.g., curved portions) that have substantially the same shape as one another (e.g., shape of a half-period of a sinusoid; the first portion 348a extends a length along the plane 346 that is substantially equal to that of a second portion 348b and the first portion 348a deviates from the plane 346 with a maximum distance that is substantially equal to that of the second portion 348b). The maximum deviation of the at least one piezoelectric element 340 from the plane 346 can be in a range of 1 millimeter to 8 millimeters (e.g., in a range of 2 millimeters to 5 millimeters). Larger deviations of the non-planar piezoelectric element 340 from the plane 346 can result in lower natural vibration frequencies of the non-planar piezoelectric element 340.

In certain implementations, the portion 342 of the at least one piezoelectric element 340 is affixed to the coupler 320 and has a cross-sectional shape that extends substantially perpendicularly to the central axis 322 of the coupler 320. For example, as schematically illustrated by FIG. 2A, the portion 342 extends along the plane 346 (e.g., is coincident with the plane 346; is substantially parallel to the plane 346). In certain other implementations, the portion 342 extends at an acute angle relative to the central axis 322 of the coupler 320. For example, as schematically illustrated by FIG. 2B, the portion 342 extends at an acute angle relative to the plane 346 (e.g., in a range of 10 degrees to 90 degrees; in a range of 20 degrees to 70 degrees; in a range of 30 degrees to 60 degrees). In certain implementations, the portion 342 extends substantially perpendicularly to an outer surface 326 of the coupler 320 (e.g., as schematically illustrated by FIGS. 2A and 2B), while in certain other implementations, the portion 342 extends at an acute angle relative to the outer surface 326 of the coupler 320. For example, as schematically illustrated in FIG. 2B, the portion 342 can have an acute angle that generally matches an angle of an adjacent sinusoidal portion of the cross-sectional shape. In certain implementations the acute angle spreads the deviations from a planar shape over a larger region and avoids having a smaller radius of curvature of the piezoelectric element 340 (e.g., smaller than a radius of curvature of a transition between a flat portion and a curved portion as in FIG. 2A) which could otherwise generate higher stresses and decrease robustness of the actuator 310.

In certain implementations, the at least one edge portion 344 of the at least one piezoelectric element 340 is affixed to the at least one mass 330 and has a cross-sectional shape that extends substantially perpendicularly to the central axis 322 of the coupler 320. For example, as schematically illustrated by FIG. 2A, the at least one edge portion 344 extends along the plane 346 (e.g., is coincident with the plane 346; is substantially parallel to the plane 346). In certain other implementations, the at least one edge portion 344 extends at an acute angle relative to the central axis 322 of the coupler 320. For example, as schematically illustrated by FIG. 2B, the portion 342 extends at an acute angle relative to the plane 346 (e.g., in a range of 10 degrees to 90 degrees; in a range of 20 degrees to 70 degrees; in a range of 30 degrees to 60 degrees). In certain implementations, the at least one edge portion 344 extends substantially perpendicularly to an outer surface 332 of the at least one mass 330 (e.g., as schematically illustrated by FIGS. 2A and 2B), while in certain other implementations, the at least one edge portion 344 extends at an acute angle relative to the outer surface 332 of the at least one mass 330. For example, as schematically illustrated in FIG. 2B, the edge portion 344 can have an acute angle that generally matches an angle of an adjacent sinusoidal portion of the cross-sectional shape. In certain implementations, the acute angle spreads the deviations from a planar shape over a larger region and avoids having a smaller radius of curvature of the piezoelectric element 340 (e.g., smaller than a radius of curvature of a transition between a flat portion and a curved portion as in FIG. 2A) which could otherwise generate higher stresses and decrease robustness of the actuator 310.

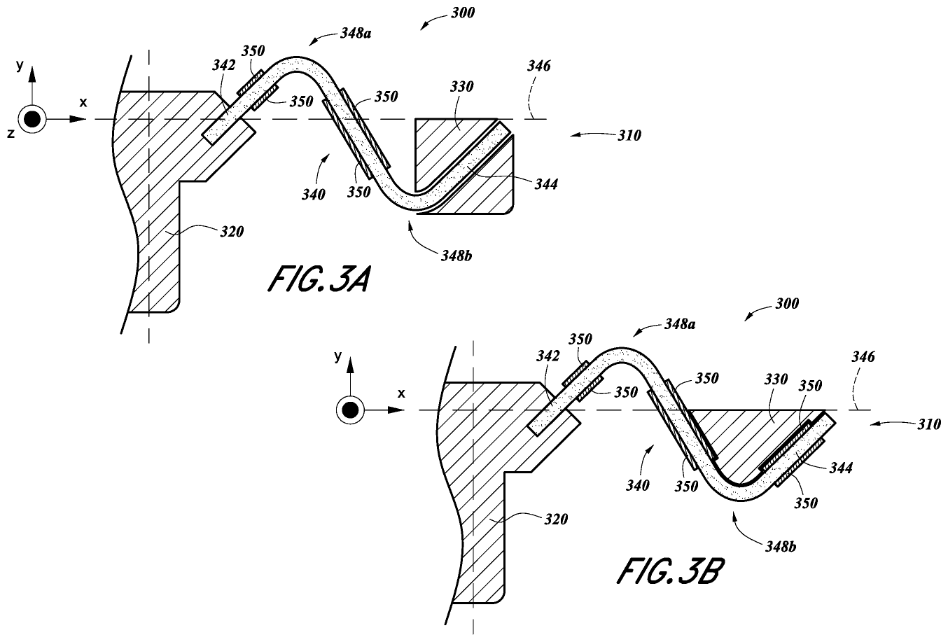

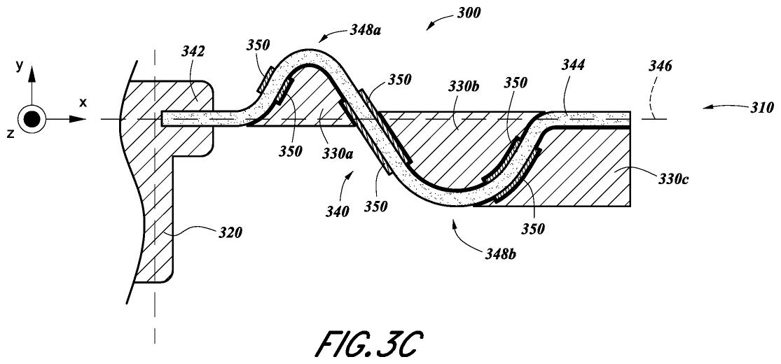

In certain implementations, as schematically illustrated by FIGS. 2A and 2B, the at least one edge portion 344 of the at least one piezoelectric element 340 extends only partially into the at least one mass 330 such that the at least one edge portion 344 is substantially surrounded by the at least one mass 330 (e.g., the at least one mass 330 extends over a top surface, side surface or edge face, and bottom surface of the edge portion 344). In certain other implementations, the at least one edge portion 344 extends completely through the at least one mass 330 such that the at least one edge portion 344 is not wholly surrounded by the at least one mass 330. For example, as schematically illustrated by FIG. 3A, the at least one mass 330 extends over (e.g., covers) a top surface and a bottom surface of the edge portion 344 but not over (e.g., not covering) a side surface (e.g., an edge face) of the edge portion 344 between the top and bottom surfaces.

In certain implementations, the at least one mass 330 comprises at least one unitary mass 330 affixed to the at least one piezoelectric element 340 in a region at least partially bounded by a portion 348 of the non-planar piezoelectric element 340 that deviates from a planar shape (e.g., deviates from the plane 346). For example, as schematically illustrated by FIG. 3B, a unitary mass 330 is affixed to the non-planar piezoelectric element 340 in a region at least partially bounded by the portion 348b that deviates from the plane 346. In the example shown in FIG. 3B, the unitary mass 330 extends over (e.g., covers) the top surface, but not over (e.g., not covering) the bottom surface or side surface (e.g., an edge face) of the edge portion 344.

In certain implementations, the at least one mass 330 comprises a plurality of unitary masses 330 affixed to and distributed along the at least one non-planar piezoelectric element 340 (e.g., along more than the at least one edge portion 344). By having the at least one mass 330 distributed along the piezoelectric element 340, certain implementations described herein can utilize space more efficiently (e.g., can fit into a smaller volume). While described herein in conjunction with a non-planar (e.g., not substantially flat) piezoelectric element 340, such distribution of the at least one mass 330 can also be used for planar (e.g., substantially flat) piezoelectric elements.

For example, as schematically illustrated by FIG. 3C, three unitary masses 330a,b,c are affixed to and distributed along the at least one non-planar piezoelectric element 340. One or more of these unitary masses 330 can be within regions at least partially bounded by the one or more portions 348 that deviate from the plane 346 (e.g., unitary masses 330a,b in regions at least partially bounded by portions 348a,b, respectively) and/or the at least one edge portion 344 is not wholly surrounded by the plurality of unitary masses (e.g., the unitary mass 330c extends over or covers only a bottom surface of the edge portion 344 but not over or not covering the top surface or side surface (e.g., an edge face) of the edge portion 344). While the unitary masses 330 of FIGS. 3B and 3C are schematically illustrated to have surfaces that are at least partially bounded by and/or extend along (e.g., coincident with; substantially parallel to) the plane 346, in certain other implementations, the surfaces of the unitary masses 330 extend at least partially past (e.g., are not at least partially bounded by and/or do not extend along) the plane 346.

In certain implementations, the apparatus 300 further comprises a plurality of electrodes 350 affixed to the at least one non-planar piezoelectric element 340 and positioned at portions of the cross-sectional shape having a non-zero slope relative to a plane 346 extending from the coupler 320 to the at least one mass 330. For example, as schematically illustrated in FIGS. 2A, 2B, and 3A-3C, the plurality of electrodes 350 can be positioned at one or more straight portions and/or curved portions of the piezoelectric element 340 (e.g., a portion between two points of maximum deviation from the plane 346; a portion between the portion 342 and a point of maximum deviation from the plane 346; a portion between a point of maximum deviation from the plane 346 and the end portion 344).

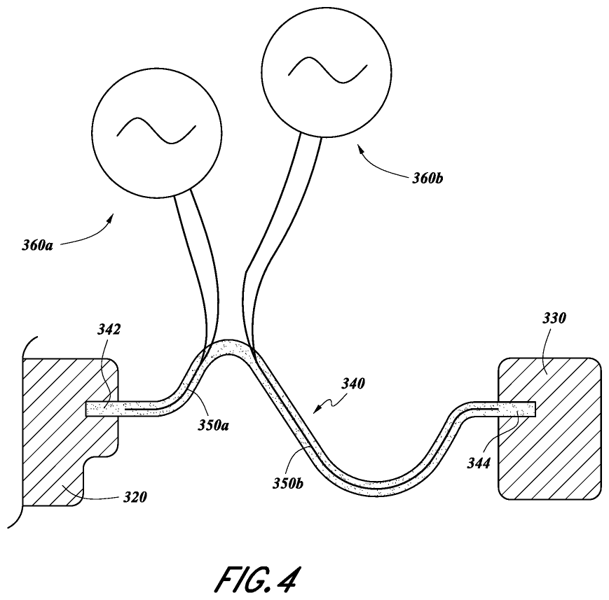

In certain implementations, the plurality of electrodes 350 are integral with the at least one piezoelectric element 340 (e.g., one or more electrically conductive layers on or between layers of piezoelectric material) and are configured to apply different electrical voltage signals to different portions of the at least one piezoelectric element 340. For example, as schematically illustrated by FIG. 4, the plurality of electrodes 350 comprises a first plurality of electrodes 350a in electrical communication with a first electrical voltage signal source 360a (e.g., drive circuitry) and a second plurality of electrodes 350b in electrical communication with a second electrical voltage signal source 360b (e.g., drive circuitry) that is configured to be operated independently from the first electrical voltage signal source 360a. The first plurality of electrodes 350a are in operative communication with a corresponding portion of the piezoelectric element 340 (e.g., proximal to the portion 342) and the second plurality of electrodes 350b are in operative communication with a corresponding portion of the piezoelectric element 340 (e.g., proximal to the portion 344). In certain such implementations, the different portions of the piezoelectric element 340 can be independently driven by the first and second electrical voltage signal sources 360a,b.

In certain implementations, the non-planar piezoelectric element 340 and the plurality of electrodes 350 are configured to provide motion of the at least one mass 330 in two substantially orthogonal directions. For example, a first component of the motion can be in a first direction substantially along the plane 346 and substantially within the cross-sectional plane of FIGS. 2A-2B and 3A-3C (e.g., the x-direction) and a second component of the motion can be in a second direction that is substantially perpendicular to the first direction (e.g., the y-direction; substantially perpendicular to the plane 346 and substantially within the cross-sectional plane of FIGS. 2A-2B and 3A-3C). In certain implementations, the maximum magnitude of the motion in the first and second directions are substantially equal to one another, while in certain other implementations the maximum magnitude of the motion in the second direction is less than or equal to ten times the maximum magnitude of the motion in the first direction.

The amount of movement in each of the two substantially orthogonal directions can be tuned by selectively positioning and/or activating the electrodes 350 on different portions of the piezoelectric element 340. For example, positioning and/or activating electrodes 350 at portions of the piezoelectric element 340 that extend substantially perpendicularly to the x-direction can increase motion along the x-direction than positioning and/or activating electrodes 350 at portions of the piezoelectric element 340 that extend substantially parallel to the x-direction. For another example, the non-planar shape of the piezoelectric element 340 can be configured to have more of its length substantially parallel to the y-direction than the x-direction to favor motion in the x-direction, and vice versa.

As compared to prior piezoelectric-based actuators in which motion only along a single direction (e.g., the y-direction) is used, the actuator 310 of certain implementations described herein utilizes motion in the two substantially orthogonal directions (e.g., in both x- and y-directions) and can achieve the same acoustic output with less motion in the single direction (e.g., the y-direction). As a result, certain such implementations can allow more robust designs utilizing less clearance around the at least one mass 330 in the y-direction in environments in which height of the actuator 310 in the y-direction is more of a premium than width in the x-direction and/or greater acoustic output achieved by a smaller actuator 310.

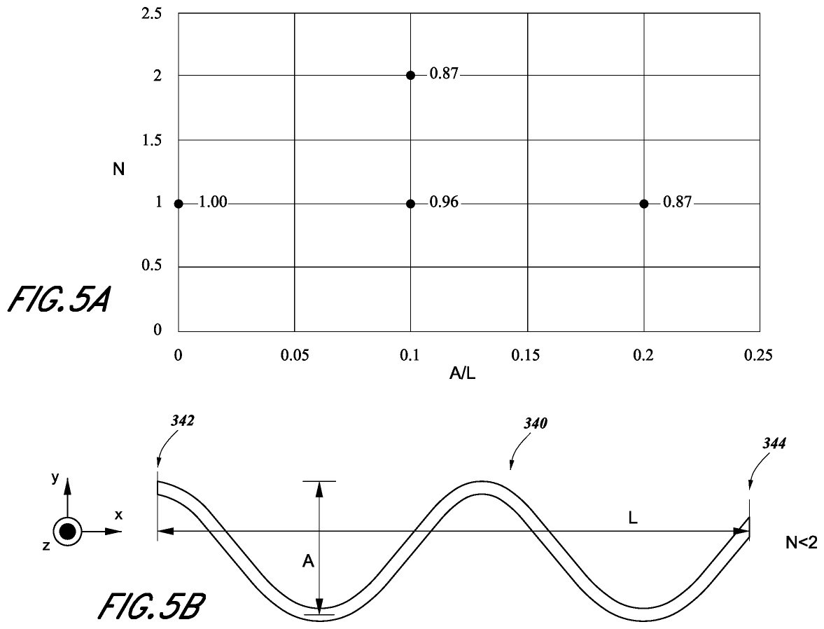

FIG. 5A shows example calculations of the natural frequency of an example parametric model of a piezoelectric element 340 having a sinusoidal cross-sectional shape, schematically illustrated in FIG. 5B, as a function of number of periods (N) and the ratio (A/L) of amplitude (A) to length (L) of the piezoelectric element 340 in accordance with certain implementations described herein. The values of FIG. 5A are shown in relation to the natural frequency of a planar (e.g., flat) piezoelectric element having an amplitude A=0. The natural frequency is proportional to the square root of the stiffness of the piezoelectric element 340. Therefore, the values of FIG. 5A are independent of the width (e.g., in a direction perpendicular to the cross-section shown in FIG. 5B) and the thickness of the piezoelectric element 340, since stiffnesses of both the flat piezoelectric element and the sinusoidal piezoelectric element 340 have the same dependence on these dimensions and cancel each other out.

For example, for a sinusoidal-shaped piezoelectric element 340 having N=1 and A/L=0.1, the natural frequency is 96% of the natural frequency of the flat piezoelectric element having the same length, while for a sinusoidal-shaped piezoelectric element 340 having N=1 and A/L=0.2, the natural frequency is 87% of the natural frequency of the flat piezoelectric element having the same length. Thus, FIG. 5A shows that the natural frequency of the sinusoidal-shaped piezoelectric element 340 decreases with increasing amplitude A. For another example, for a sinusoidal-shaped piezoelectric element 340 having N=2 and A/L=0.1, the natural frequency is 87% of the natural frequency of the flat piezoelectric element having the same length. Thus, FIG. 5A shows that the natural frequency of the sinusoidal-shaped piezoelectric element 340 decreases with increasing number of periods N. In certain implementations, both the number of periods and the amplitude are configured to provide a predetermined natural frequency (e.g., in the auditory range of frequencies for an actuator of an auditory prosthesis) within any constraints resulting from a limited amount of space available for the actuator (e.g., housing size).

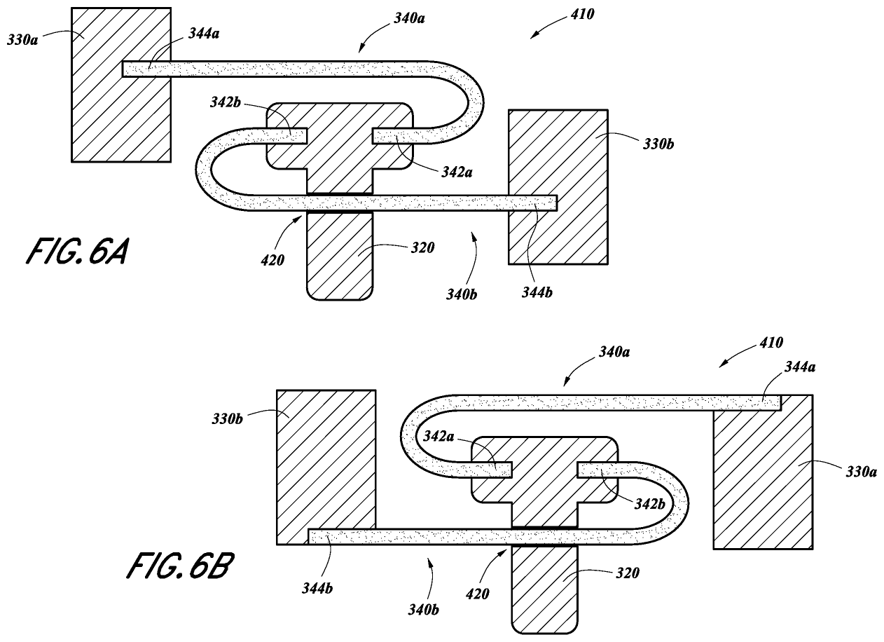

FIGS. 6A and 6B schematically illustrate cross-sectional views of two example actuators 410 in accordance with certain implementations described herein. Each actuator 410 of FIGS. 6A and 6B comprises a coupler 320, a pair of masses 330a,b, and at least one non-planar piezoelectric element 340. FIGS. 6A and 6B show the at least one non-planar piezoelectric element 340 comprising a pair of piezoelectric arms 340a,b having corresponding first portions 342a,b affixed to the coupler 320 and corresponding second portions 344a,b affixed to a corresponding mass 330a,b. In certain other implementations, the at least one non-planar piezoelectric element 340 comprises a single (e.g., unitary) serpentine-shaped piezoelectric element 340 having the first portions 342a,b and second portions 344a,b.

In FIGS. 6A and 6B, the first portion 342a,b is on an opposite side of the coupler 320 than is the second portion 344a,b, the first piezoelectric arm 340a is curved upward and over the coupler 320 from one side of the coupler 320 to the other, the coupler 320 comprises a passage 420, and the second piezoelectric arm 340b is curved downward and through the passage 420 from one side of the coupler 320 to the other. In certain other implementations, the coupler 320 and the second piezoelectric arm 340b are offset from one another in a direction substantially perpendicular to the plane of FIGS. 6A and 6B. ]In FIG. 6A, the mass 330a is on the left side of the coupler 320 and substantially surrounds an edge face of the first piezoelectric arm 340a and the mass 330b is on the right side of the coupler 320 and substantially surrounds an edge face of the second piezoelectric arm 340b. In FIG. 6B, the mass 330a is on the right side of the coupler 320 and does not substantially surround an edge face of the first piezoelectric arm 340a and the mass 330b is on the left side of the coupler 320 and does not substantially surround an edge face of the second piezoelectric arm 340b. The masses 330a,b of FIG. 6B are affixed to the first and second piezoelectric arms 340a,b such that an overall height of the actuator 410 is less than the overall height of the actuator 410 of FIG. 6A. In certain such implementations, the overall length of the actuator 410 (e.g., from one mass 330a to the other mass 330b) is shorter than the overall length of the actuator 310 of FIGS. 2A-2B and 3A-3C.

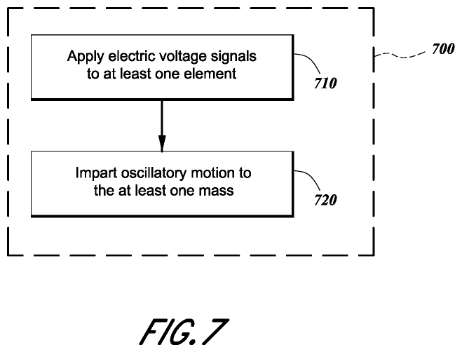

FIG. 7 is a flow diagram of an example method 700 in accordance with certain implementations described herein. In an operational block 710, the method 700 comprises applying electric voltage signals to at least one element responsive to the electric voltage signals by changing in shape and/or length (e.g., at least one piezoelectric element 340). The at least one element has a first portion (e.g., portion 342) in mechanical communication with a fixture implanted on or within a recipient's body (e.g., via coupler 320) and a second portion (e.g., portion 344) affixed to at least one mass 330 and spaced from the first portion. In an operational block 420, the method 400 further comprises imparting oscillatory motion to the at least one mass 330 (e.g., by applying the electric voltage signals to the at least one element). The oscillatory motion comprises a first oscillating component in a first direction (e.g., an x-direction) extending from the first portion of the at least one element to the second portion of the at least one element. The first oscillating component has a first maximum amplitude. The oscillatory motion further comprises a second oscillating component in a second direction (e.g., y-direction) substantially perpendicular to the first direction. The second oscillating component has a second maximum amplitude less than or equal to ten times the first maximum amplitude.

In certain implementations, the at least one element is non-flat (e.g., non-planar; substantially not flat) (e.g., in accordance with FIGS. 2A-2B, 3A-3C, and 6A-6B). As described herein, in certain implementations, the electric voltage signals are applied to surfaces of the at least one element having a non-zero slope relative to the first direction and/or portions within the at least one element below such surfaces. In certain such implementations, the electrical voltage signals are not applied to surfaces of the at least one element that have a substantially zero slope relative to the first direction and/or portions within the at least one element below such surfaces.

Although commonly used terms are used to describe the systems and methods of certain implementations for ease of understanding, these terms are used herein to have their broadest reasonable interpretations. Although various aspects of the disclosure are described with regard to illustrative examples and implementations, the disclosed examples and implementations should not be construed as limiting. Conditional language, such as, among others, “can,” “could,” “might,” or “may,” unless specifically stated otherwise, or otherwise understood within the context as used, is generally intended to convey that certain implementations include, while other implementations do not include, certain features, elements and/or steps. Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

It is to be appreciated that the implementations disclosed herein are not mutually exclusive and may be combined with one another in various arrangements. In addition, although the disclosed methods and apparatuses have largely been described in the context of conventional cochlear implants, various implementations described herein can be incorporated in a variety of other suitable devices, methods, and contexts. More generally, as can be appreciated, certain implementations described herein can be used in a variety of implantable medical device contexts that can benefit from having at least a portion of the received power available for use by the implanted device during time periods in which the at least one power storage device of the implanted device unable to provide electrical power for operation of the implantable medical device.

Language of degree, as used herein, such as the terms “approximately,” “about,” “generally,” and “substantially,” represent a value, amount, or characteristic close to the stated value, amount, or characteristic that still performs a desired function or achieves a desired result. For example, the terms “approximately,” “about,” “generally,” and “substantially” may refer to an amount that is within ±10% of, within ±5% of, within ±2% of, within ±1% of, or within ±0.1% of the stated amount. As another example, the terms “generally parallel” and “substantially parallel” refer to a value, amount, or characteristic that departs from exactly parallel by ±10 degrees, by ±5 degrees, by ±2 degrees, by ±1 degree, or by ±0.1 degree, and the terms “generally perpendicular” and “substantially perpendicular” refer to a value, amount, or characteristic that departs from exactly perpendicular by ±10 degrees, by ±5 degrees, by ±2 degrees, by ±1 degree, or by ±0.1 degree. The ranges disclosed herein also encompass any and all overlap, sub-ranges, and combinations thereof. Language such as “up to,” “at least,” “greater than,” less than,” “between,” and the like includes the number recited. As used herein, the meaning of “a,” “an,” and “said” includes plural reference unless the context clearly dictates otherwise. Also, as used in the description herein, the meaning of “in” includes “into” and “on,” unless the context clearly dictates otherwise.

While the methods and systems are discussed herein in terms of elements labeled by ordinal adjectives (e.g., first, second, etc.), the ordinal adjective are used merely as labels to distinguish one element from another (e.g., one signal from another or one circuit from one another), and the ordinal adjective is not used to denote an order of these elements or of their use.

The invention described and claimed herein is not to be limited in scope by the specific example implementations herein disclosed, since these implementations are intended as illustrations, and not limitations, of several aspects of the invention. Any equivalent implementations are intended to be within the scope of this invention. Indeed, various modifications of the invention in form and detail, in addition to those shown and described herein, will become apparent to those skilled in the art from the foregoing description. Such modifications are also intended to fall within the scope of the claims. The breadth and scope of the invention should not be limited by any of the example implementations disclosed herein, but should be defined only in accordance with the claims and their equivalents.

1. An apparatus comprising:
at least one actuator configured to generate vibrations, the at least one actuator comprising:
a coupler configured to be in mechanical communication with a fixture;
at least one mass spaced from the coupler; and
at least one non-planar piezoelectric element in mechanical communication with the coupler and the at least one mass, the at least one non-planar piezoelectric element configured to oscillate the at least one mass relative to the coupler in response to received electric voltage signals.

2. The apparatus of claim 1, wherein the fixture and the at least one actuator are configured to be implanted on or within a recipient's body, the fixture configured to transmit the vibrations to the recipient's body such that the vibrations evoke a hearing precept by the recipient.

3. The apparatus of claim 1, further comprising a housing configured to hermetically seal the at least one mass and the at least one non-planar piezoelectric element from an environment surrounding the at least one actuator.

4. The apparatus of claim 1, wherein the at least one mass is affixed to at least one edge portion of the at least one non-planar piezoelectric element.

5. The apparatus of claim 1, wherein the at least one mass comprises a plurality of unitary masses affixed to and distributed along the at least one non-planar piezoelectric element.

6. The apparatus of claim 1, wherein the at least one non-planar piezoelectric element has a cross-sectional shape comprising one or more curves in at least one plane extending through the coupler and the at least one mass.

7. The apparatus of claim 6, wherein the cross-sectional shape comprises a first portion affixed to the coupler and extending substantially perpendicularly to a central axis of the coupler.

8. The apparatus of claim 6, wherein the cross-sectional shape comprises a first portion affixed to the coupler and extending at an acute angle relative to a central axis of the coupler.

9. The apparatus of claim 7, wherein the cross-sectional shape comprises at least one second portion affixed to the at least one mass and extending at an angle that is less than or equal to 90 degrees relative to the central axis.

10. The apparatus of claim 6, further comprising a plurality of electrodes affixed to the at least one non-planar piezoelectric element and positioned at portions of the cross-sectional shape having a non-zero slope relative to a plane extending from the coupler to the at least one mass.

11. The apparatus of claim 1, wherein the at least one non-planar piezoelectric element has a length between the coupler and the at least one mass, a width perpendicular to the length, and a thickness perpendicular to the width and the length, the at least one non-planar piezoelectric element having a first natural vibration frequency that is less than a second natural vibration frequency of a planar piezoelectric element having the length, the width, and the thickness.

12. A method comprising:
applying electric voltage signals to at least one element responsive to the electric voltage signals by changing in shape and/or length, the at least one element having a first portion in mechanical communication with a fixture implanted on or within a recipient's body and a second portion affixed to at least one mass and spaced from the first portion; and
imparting oscillatory motion to the at least one mass, said oscillatory motion comprising:
a first oscillating component in a first direction extending from the first portion of the at least one element to the second portion of the at least one element, the first oscillating component having a first maximum amplitude; and
a second oscillating component in a second direction substantially perpendicular to the first direction, the second oscillating component having a second maximum amplitude less than or equal to ten times the first maximum amplitude.

13. The method of claim 12, wherein the at least one element is non-flat.

14. The method of claim 13, wherein said applying electric voltage signals comprises applying the electric voltage signals to surfaces of the at least one element that have a non-zero slope relative to the first direction.

15. The method of claim 14, wherein said applying electric voltage signals comprises not applying the electric voltage signals to surfaces of the at least one element that have a substantially zero slope relative to the first direction.

16. An apparatus comprising:
a coupler configured to be in mechanical communication with a fixture implanted on or within a recipient's body;
at least one piezoelectric element in mechanical communication with the coupler, the at least one piezoelectric element comprising an edge face spaced from the coupler; and
at least one mass affixed to the at least one piezoelectric element, the at least one mass spaced from the coupler and not covering the edge face of the at least one piezoelectric element.

17. The apparatus of claim 16, wherein the at least one mass comprises a plurality of masses distributed along a line extending from the coupling portion to the edge face of the at least one piezoelectric element.

18. The apparatus of claim 16, wherein the at least one piezoelectric element is substantially flat.

19. The apparatus of claim 16, wherein the at least one piezoelectric element is not substantially flat.

20. The apparatus of claim 16, wherein the at least one piezoelectric element is configured to vibrate, in response to electrical voltage signals applied to the at least one piezoelectric element, with a frequency in a range of 250 Hz to 8 kHz.
